(19) United States
(12) Patent Application Publication
(10) Pub. No.: US 2021/0387390 A1
(43) Pub. Date: Dec. 16, 2021

(54) INJECTION MOLDING HAVING VARIABLE VOLUME RECOVERY

(71) Applicant: IMFLUX INC., Hamilton, OH (US)

(72) Inventors: Brandon Michael Birchmeier, Morrow, OH (US); Brian Matthew Burns, Mason, OH (US); Gene Michael Altonen, West Chester, OH (US); William Francis Lawless, III, Medford, MA (US)

(21) Appl. No.: 17/326,597

(22) Filed: May 21, 2021

Related U.S. Application Data
(60) Provisional application No. 63/039,344, filed on Jun. 15, 2020.

(51) Int. Cl. B29C 45/76; B29C 45/46; B29C 45/47

(52) U.S. Cl. CPC B29C 45/762; B29C 45/461; B29C 2945/76648; B29C 2945/7619; B29C 45/47

(57) ABSTRACT

Systems and approaches for controlling an injection molding machine having a mold forming a mold cavity include feeding a molten polymer into a barrel containing a screw disposed in a first position, advancing the screw a first instance, from the first position to a second position, to inject the molten polymer into the mold cavity to form a molded part, and ejecting a first molded part or a first set of molded parts from the mold cavity. Further, the screw is advanced a second instance, from the second position to a third position, to inject the molten polymer into the mold cavity to form an additional molded part. A second molded part or a second set of molded parts is ejected from the mold cavity. After the second advancing instance, a recovery profile is commenced in which the screw is returned to the first position.

### CROSS REFERENCE TO RELATED APPLICATIONS

This application claims the benefit of U.S. Provisional Application No. 63/039,344, filed on Jun. 15, 2020, the entirety of which is herein expressly incorporated by reference.

### FIELD OF THE DISCLOSURE

The present disclosure relates generally to injection molding and, more particularly, to approaches for controlling injection molding machines using variable volume recovery mechanisms.

### BACKGROUND

Injection molding is a technology commonly used for high-volume manufacturing of parts constructed of thermoplastic materials. During repetitive injection molding processes, a thermoplastic resin, typically in the form of small pellets or beads, is introduced into an injection molding machine which melts the pellets under heat and pressure. In an injection cycle, the molten material is forcefully injected into a mold cavity having a particular desired cavity shape. The injected plastic is held under pressure in the mold cavity and is subsequently cooled and removed as a solidified part having a shape closely resembling the cavity shape of the mold. A single mold may have any number of individual cavities which can be connected to a flow channel by a gate that directs the flow of the molten resin into the cavity. A typical injection molding procedure generally includes four basic operations: (1) heating the plastic in the injection molding machine to allow the plastic to flow under pressure; (2) injecting the melted plastic into a mold cavity or cavities defined between two mold halves that have been closed; (3) allowing the plastic to cool and harden in the cavity or cavities while under pressure; and (4) opening the mold halves and ejecting the part from the mold.

In conventional systems, after the melted plastic is injected into the mold cavity or cavities, the device that injects the melted plastic into the mold cavity or cavities (e.g., a screw or an auger) enters a recovery phase in which it returns to an original position prior to commencing a subsequent injection cycle. As a non-limiting example, this recovery process may begin upon ejecting the part from the mold. This recovery process may be time-consuming, and thus may lead to overall cycle inefficiencies. Further, in these systems, substantial energy is needed to urge the screw to the initial position. Accordingly, the screw experiences substantial shearing and other forces during the recovery phase that may adversely impact the life of the screw.

### SUMMARY

Embodiments within the scope of the present invention are directed to the control of injection molding machines to produce repeatably consistent parts. Systems and approaches for controlling the injection molding machine having a mold forming a mold cavity and being controlled according to an injection cycle include feeding a molten polymer into a barrel containing a screw disposed in a first position, advancing the screw a first instance, from the first position to a second position, to inject the molten polymer into the mold cavity to form a molded part, and ejecting a first molded part or a first set of molded parts from the mold cavity. Further, the screw is advanced a second instance, from the second position to a third position, to inject the molten polymer into the mold cavity to form an additional molded part. A second molded part or a second set of molded parts is ejected from the mold cavity. After the second advancing instance, a recovery profile is commenced in which the screw is returned to the first position.

In some examples, a hold pattern is commenced after the screw is advanced from the first position to the second position. In some examples, the method may include determining, via a sensor, a sensed volume of molten polymer disposed within the barrel or a suitable proxy for a sensed volume of molten polymer disposed within the barrel. In some examples, the sensor may be in the form of a screw position sensor and/or a melt travel sensor.

The sensed volume of molten polymer disposed within the barrel is compared with a fill volume associated with the mold cavity. In these examples, the screw is advanced from the second position to the third position only if the volume of the molten polymer disposed within the barrel is greater than the fill volume associated with the mold cavity.

In accordance with another aspect, an injection molding machine includes an injection unit having a mold forming a mold cavity and a barrel, a sensor coupled with the injection unit, a controller coupled with the injection unit and the sensor. The mold cavity has a fill volume. The barrel contains a screw that is movable within the barrel. The injection unit is adapted to receive and inject a molten plastic material into the mold cavity via the screw to form a molded part. The sensor is adapted to measure at least one characteristic of the molten polymer in the barrel. The controller is adapted to control operation of the injection molding machine according to an injection cycle. Further, the controller is adapted to compare the measured characteristic of the barrel with the fill volume of the cavity. Upon the measured characteristic of the barrel exceeding a threshold value, the controller is configured to advance the screw from the first position to a second position to inject the molten polymer into the mold cavity to form a first molded part or a first set of molded parts.

In accordance with yet another aspect, a non-transitory computer-readable storage medium is adapted to store processor-executable instructions that, when executed, cause one or more processors to feed a molten polymer into a barrel containing a screw disposed in a first position. Further, the one or more processors commence an injection cycle by transmitting a signal to an actuator, such as a screw control, that advances the screw a first instance, from the first position to a second position, to inject the molten polymer into the mold cavity to form a molded part, eject a first molded part or a first set of molded parts from the mold cavity, advances the screw a second instance, from the second position to a third position, to inject the molten polymer into the mold cavity to form a molded part, eject a second molded part or a second set of molded parts from the mold cavity, and commence a recovery profile in which the screw is returned to the first position.

In accordance with another aspect, an approach for controlling an injection molding machine having a mold forming a mold cavity is provided where the injection molding machine is controlled according to an injection cycle. The approach includes feeding a molten polymer into a barrel containing a screw and injecting a plurality of intermediate shots of molten polymer into the mold cavity by advancing the screw. For each of the plurality of intermediate shots, a cooling step is performed whereby the molten polymer cools within the mold cavity and a molded part or a set of molded parts is ejected from the mold cavity. No energy is consumed between the cooling step and the ejecting step for the plurality of intermediate shots. A final shot of molten polymer is injected into the mold cavity by advancing the screw, and a final cooling step and final ejecting step are performed. Energy is consumed between the final cooling step and the final ejecting step.

In accordance with another aspect, an approach for controlling an injection molding machine having a mold forming a mold cavity is provided where the injection molding machine is controlled according to an injection cycle. The approach includes feeding a molten polymer into a barrel containing a screw and injecting a plurality of successive shots of molten polymer into the mold cavity by advancing the screw. A highest energy consumption value of the injection cycle occurs in a final shot of the plurality of successive shots of molten polymer injected into the mold cavity.

### BRIEF DESCRIPTION OF THE DRAWINGS

While the specification concludes with claims particularly pointing out and distinctly claiming the subject matter that is regarded as the present invention, it is believed that the invention will be more fully understood from the following description taken in conjunction with the accompanying drawings. Some of the figures may have been simplified by the omission of selected elements for the purpose of more clearly showing other elements. Such omissions of elements in some figures are not necessarily indicative of the presence or absence of particular elements in any of the exemplary embodiments, except as may be explicitly delineated in the corresponding written description. None of the drawings are necessarily to scale. For example, the dimensions and/or relative positioning of some of the elements in the figures may be exaggerated relative to other elements to help to improve understanding of various embodiments of the present invention.

FIG. 1 illustrates a schematic view of an example first injection molding machine having a controller coupled therewith in accordance with various embodiments of the present disclosure;

FIG. 2 illustrates an example injection cycle for use with an injection molding machine in accordance with various embodiments of the present disclosure;

FIG. 3 illustrates an example flow diagram of a variable volume recovery process for an injection molding machine in accordance with various embodiments of the present disclosure;

FIG. 4 illustrates an example energy consumption graph over successive injection cycles in accordance with conventional approaches;

FIG. 5 illustrates an example energy consumption graph over successive injection cycles in accordance with various embodiments of the present disclosure;

FIG. 6 illustrates an example total energy consumption graph over successive injection cycles in accordance with conventional approaches; and

FIG. 7 illustrates an example total energy consumption graph over successive injection cycles in accordance with various embodiments of the present disclosure.

### DETAILED DESCRIPTION

Generally speaking, aspects of the present disclosure include systems and approaches for controlling an injection molding machine where operational parameters are adjusted to ensure a consistent volume of injected plastic at a consistent molten material viscosity. In these systems and approaches, upon initiation of the injection cycle whereby in a first shot, molten plastic is injected into a mold cavity, instead of initiating a recovery profile where the injection molding machine returns to an original position, the machine is maintained in a “holding” position. After a first molded part or a first set of molded parts is ejected from the mold, the machine then injects a second shot whereby additional molten polymer is injected into the mold cavity to form a subsequent molded part or subsequent set of molded parts. The injection molding machine then determines if additional molded parts may be formed prior to initiating the recovery profile, and, if so, proceeds to inject a third, and any successive shots whereby additional molten material is again injected into the mold cavity to form a subsequent molded part or parts. If the machine determines it cannot form additional molded parts prior to initiating the recovery, the machine then initiates the recovery profile, thereby advancing to the original position.

In some examples, the injection molding machine first calculates (i.e., measures and/or senses) a volume of molten polymer remaining to be used in successive mold cycles to determine whether successive cycles may be performed prior to initiating the recovery profile. Such calculations may be performed via any number of suitable sensors or sensing mechanisms.

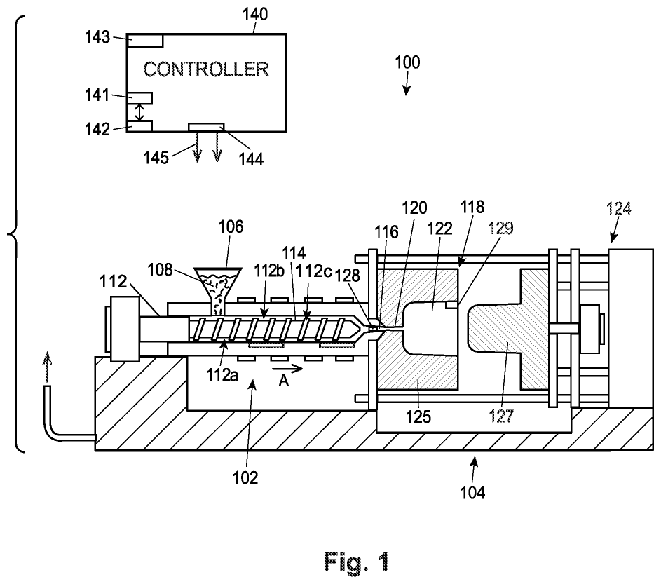

Turning to the drawings, an injection molding process is herein described. The approaches described herein may be suitable for electric presses, servo-hydraulic presses, hydraulic presses, and other known machines. As illustrated in FIG. 1, the injection molding machine 100 includes an injection unit 102 and a clamping system 104. The injection unit 102 includes a hopper 106 adapted to accept material in the form of pellets 108 or any other suitable form. In many of these examples, the pellets 108 may be a polymer or polymer-based material. Other examples are possible.

The hopper 106 feeds the pellets 108 into a heated barrel 110 of the injection unit 102. Upon being fed into the heated barrel 110, the pellets 108 may be driven to the end of the heated barrel 110 by a reciprocating screw 112 that is movable from a first, original position 112a to a number of subsequent positions for inject the first, second, third, and/or any subsequent shots. The heating of the heated barrel 110 and the compression of the pellets 108 by the reciprocating screw 112 causes the pellets 108 to melt, thereby forming a molten plastic material 114. The molten plastic material 114 is typically processed at a temperature selected within a range of about 130° C. to about 410° C. (with manufacturers of particular polymers typically providing injection molders with recommended temperature ranges for given materials).

In operation, a controller 140 coupled with the injection molding machine 110 commences an injection cycle by causing the reciprocating screw 112 to advance forward from the first position 112a to a second position 112b to urge the molten plastic material 114 toward a nozzle 116 to form a first shot of plastic material that will ultimately be injected into a mold cavity 122 of a mold 118 via one or more gates 120 which direct the flow of the molten plastic material 114 to the mold cavity 122. In other words, the reciprocating screw 112 is driven to exert a force on the molten plastic material 114. In other embodiments, the nozzle 116 may be separated from one or more gates 120 by a feed system (not illustrated). The mold cavity 122 is formed between the first and second mold sides 125, 127 of the mold 118 and the first and second mold sides 125, 127 are held together under pressure via a press or clamping unit 124. The mold cavity 122 has a fill volume associated therewith.

The press or clamping unit 124 applies a predetermined clamping force during the molding process which is greater than the force exerted by the injection pressure acting to separate the two mold halves 125, 127, thereby holding together the first and second mold sides 125, 127 while the molten plastic material 114 is injected into the mold cavity 122. To support these clamping forces, the clamping system 104 may include a mold frame and a mold base, in addition to any other number of components, such as a tie bar.

Once the first shot of molten plastic material 114 is injected into the mold cavity 122, the reciprocating screw 112 halts forward movement. The molten plastic material 114 takes the form of the mold cavity 122 and cools inside the mold 118 until the plastic material 114 solidifies. Upon solidifying, the press 124 releases the first and second mold sides 115, 117, which are then separated from one another. The finished part may then be ejected from the mold 118. The mold 118 may include any number of mold cavities 122 to increase overall production rates. The shapes and/or designs of the cavities may be identical, similar to, and/or different from each other. For instance, a family mold may include cavities of related component parts intended to mate or otherwise operate with one another. In some forms, an “injection cycle” is defined as of the steps and functions performed between commencement of injection and ejection.

As previously noted, the injection molding machine 100 also includes a controller 140 communicatively coupled with the machine 100 via connection 145. The connection 145 may be any type of wired and/or wireless communications protocol adapted to transmit and/or receive electronic signals. In these examples, the controller 140 is in signal communication with at least one sensor, such as, for example, sensor 128 located in or near the nozzle 116 and/or a sensor 129 located in or near the mold cavity 122. In some examples, the sensor 128 is located at a leading end of the screw 112 and the sensor 129 is located in a manifold or a runner of the injection machine 100. Alternatively, the sensor 128 may be located at any position ahead of the check ring of the screw 112. Any number of additional real and/or virtual sensors capable of sensing any number of characteristics of the mold 118 and/or the machine 100 may be used and placed at desired locations of the machine 100. In some examples, the sensor 128 may be in the form of a screw position sensor or a melt travel sensor. As a further example, any type of sensor capable of detecting flow front progression in the mold cavity 122 may be used.

The controller 140 can be disposed in a number of positions with respect to the injection molding machine 100. As examples, the controller 140 can be integral with the machine 100, contained in an enclosure that is mounted on the machine, contained in a separate enclosure that is positioned adjacent or proximate to the machine, or can be positioned remote from the machine. In some embodiments, the controller 140 can partially or fully control functions of the machine via wired and/or wired signal communications as known and/or commonly used in the art.

The sensor 128 may be any type of sensor adapted to measure (either directly or indirectly) one or more characteristics of the molten plastic material 114 and/or portions of the machine 100 (e.g., the barrel 110 and/or the screw 112) to determine a volume of molten plastic material 114 remaining in the barrel 110 to be used for subsequent shots. The sensor 128 may or may not be in direct contact with the molten plastic material 114.

The sensor 128 generates a signal which is transmitted to an input of the controller 140. If the sensor 128 is not located within the nozzle 116, the controller 140 can be set, configured, and/or programmed with logic, commands, and/or executable program instructions to provide appropriate correction factors to estimate or calculate values for the measured characteristic (i.e., the remaining volume of molten plastic material 114 within the barrel 110). For example, as previously noted, the sensor 128 may be programmed to measure a screw position or melt travel.

If incorporated into the injection molding machine 100, the sensor 129 may be any type of sensor adapted to measure (either directly or indirectly) one or more characteristics of the molten plastic material 114 to detect its presence and/or condition in the mold cavity 122. In various embodiments, the sensor 129 may be located at or near an end-of-fill position in the mold cavity 122. The sensor 129 may measure any number of characteristics of the molten plastic material 114 and/or the mold cavity 122 that are known in the art, such as pressure, temperature, viscosity, flow rate, hardness, strain, optical characteristics such as translucency, color, light refraction, and/or light reflection, and the like, or any one or more of any number of additional characteristics indicative of these. The sensor 129 may or may not be in direct contact with the molten plastic material 114. As an example, the sensor 129 may be a pressure transducer that measures a cavity pressure of the molten plastic material 114 within the cavity 122. The sensor 129 generates a signal which is transmitted to an input of the controller 140. Any number of additional sensors may be used to sense and/or measure operating parameters.

The controller 140 is also in signal communication with a screw control 126. In some embodiments, the controller 140 generates a signal which is transmitted from an output of the controller 140 to the screw control 126. The controller 140 can control any number of characteristics of the machine, such as injection pressures (by controlling the screw control 126 to advance the screw 112 at a rate which maintains a desired value corresponding to the molten plastic material 114 in the nozzle 116), barrel temperatures, clamp closing and/or opening speeds, cooling time, inject forward time, overall cycle time, pressure set points, ejection time, screw recovery speed, a time when the screw initiates recovery, and/or back pressure values exerted on the screw 112.

The signal or signals from the controller 140 may generally be used to control operation of the molding process such that variations in material viscosity, mold temperatures, melt temperatures, and other variations influencing filling rate are taken into account by the controller 140. Alternatively or additionally, the controller 140 may make necessary adjustments in order to control for material characteristics such as volume and/or viscosity. Adjustments may be made by the controller 140 in real time or in near-real time (that is, with a minimal delay between sensors 128, 129 sensing values and changes being made to the process), or corrections can be made in subsequent cycles. Furthermore, several signals derived from any number of individual cycles may be used as a basis for making adjustments to the molding process. The controller 140 may be connected to the sensors 128, 129, the screw control 126, and or any other components in the machine 100 via any type of signal communication approach known in the art.

The controller 140 includes software 141 adapted to control its operation, any number of hardware elements 142 (such as, for example, a non-transitory memory module and/or processors), any number of inputs 143, any number of outputs 144, and any number of connections 145. The software 141 may be loaded directly onto a non-transitory memory module of the controller 140 in the form of a non-transitory computer readable medium, or may alternatively be located remotely from the controller 140 and be in communication with the controller 140 via any number of controlling approaches. The software 141 includes logic, commands, and/or executable program instructions which may contain logic and/or commands for controlling the injection molding machine 100 according to a mold cycle. The software 141 may or may not include an operating system, an operating environment, an application environment, and/or a user interface.

The hardware 142 uses the inputs 143 to receive signals, data, and information from the injection molding machine being controlled by the controller 140. The hardware 142 uses the outputs 144 to send signals, data, and/or other information to the injection molding machine. The connection 145 represents a pathway through which signals, data, and information can be transmitted between the controller 140 and its injection molding machine 100. In various embodiments, this pathway may be a physical connection or a non-physical communication link that works analogous to a physical connection, direct or indirect, configured in any way described herein or known in the art. In various embodiments, the controller 140 can be configured in any additional or alternate way known in the art.

The connection 145 represents a pathway through which signals, data, and information can be transmitted between the controller 140 and the injection molding machine 100. In various embodiments, these pathways may be physical connections or non-physical communication links that work analogously to either direct or indirect physical connections configured in any way described herein or known in the art. In various embodiments, the controller 140 can be configured in any additional or alternate way known in the art.

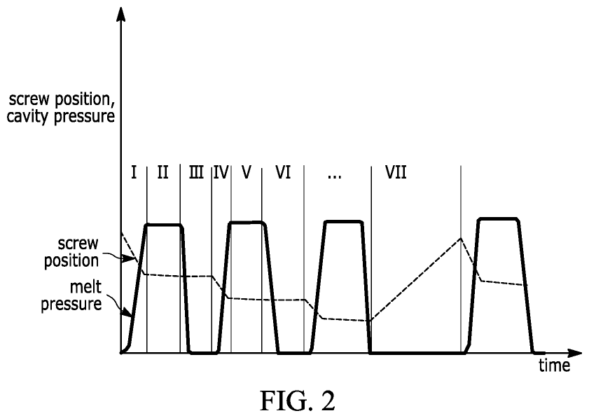

As illustrated in FIG. 2, an example injection molding cycle incorporating variable-volume recovery techniques is provided, whereby melt pressure over time is depicted in a solid line and the longitudinal position of the reciprocating screw 112 over time is depicted in a dashed line. Upon feeding the molten polymer 114 into the barrel 110 and as illustrated in step “I” of FIG. 2, the reciprocating screw 112 begins advancing forwards, thereby beginning to inject a first shot whereupon the molten plastic material 114 is fed into the mold cavity 122. This advancing of the reciprocating screw 112 causes the melt pressure to increase until a desired steady-state hold pressure is obtained (as illustrated in step “II” of FIG. 2). Here, the reciprocating screw is located at the second position 112b (FIG. 1). As illustrated in FIG. 2, in some examples, the reciprocating screw 112 may continue to slowly advance forward to maintain the desired hold pressure during this hold time. The molded part cools during this time.

Next, at a step “III” the mold cavity 122 opens (hence the sudden drop in cavity pressure), and the first molded part or first set of molded parts is ejected therefrom. As before, the reciprocating screw 112 is maintained in the second position 112b, and does not yet enter a recovery profile where it returns to the first position 112a. As will be discussed below, in some examples, the machine 100 may determine whether ample molten polymer 114 remains within the barrel 110 to proceed to step “IV”, where the mold cavity is closed, and the controller 140 commences a second injection cycle. As with step I, in this step, the reciprocating screw 112 again advances forward to begin to inject a second shot whereupon the molten plastic material 114 is fed into the mold cavity 122. As before, this advancing of the reciprocating screw 112 causes the melt pressure to increase until the desired steady-state hold pressure is obtained (as illustrated in step “V” of FIG. 2). Here, the reciprocating screw is located at a third position 112c (FIG. 1). As previously described, in some examples, the reciprocating screw 112 may continue to slowly advance forward to maintain the desired hold pressure during this hold time. The molded part cools during this time.

Once again, at step “VI” the mold cavity 122 opens, and the second molded part or second set of molded parts is ejected therefrom. In the illustrated example, upon completion of the second injection cycle, the controller 140 commences a recovery profile during which the reciprocating screw 112 returns to the initial first position 112a, whereupon subsequent injection cycles may be performed with new molten polymer 114. In some examples, the recovery profile may occur during the cooling phase. As will be described in greater detail below, in some examples, the controller 140 may cause the reciprocating screw 112 to advance additional times to complete third, fourth, fifth, sixth, or more additional shots whereby the molten polymer 114 is injected into the mold cavity 122, depending on the total volume of molten polymer 114 disposed within the barrel 110.

It is appreciated that in some examples, the injection pressure may be selectively adjusted during any of these steps (e.g., injection, mold open/close, and/or recovery). More specifically, during the mold open/part ejection steps, the pressure may be reduced while the reciprocating screw 112 maintains its position.

In some examples, the controller 140 and the sensor 128 may cooperate to determine the sensed characteristic (e.g., a quantity or volume of molten polymer 114 within the barrel 110). This calculation may be performed by determining the position of the screw and/or the melt travel of the molten polymer 114. Other suitable approaches are possible. In some examples, prior to commencing a first injection cycle, the controller 140 and sensor 128 may automatically determine the quantity or volume of molten polymer 114 disposed within the barrel 110 or a suitable proxy for such quantity or volume, such as screw position or melt pressure within the barrel, and compare this value with the overall volume of the mold cavity 122 or cavities. As a non-limiting example, the total volume of the mold cavity or cavities 122 may be approximately 1-1,000 grams, and the internal volume of the molten polymer 114 disposed within the barrel 110 may be approximately 10-5,000 grams. In some examples, the total volume of the mold cavity or cavities 122 may be calculated via a sensor (e.g., sensor 129), and in other examples, this total volume may be provided to the controller 140 during an initialization process. Upon determining these volumes, the controller 140 may perform a preliminary calculation of a number of successive shots that may be performed prior to running out of available molten polymer 114 disposed within the barrel 110. In this example, the barrel 110 contains enough molten polymer 114 to perform five successive shots without needing to return to the first position 112a and initiate the recovery profile.

As an additional non-limiting example, if each shot requires approximately 20% of the volume of molten polymer 114 disposed within the barrel 110, the machine 100 may be capable of performing five successive shots prior to entering a recovery profile. However, in some examples, a “threshold”, “buffer”, or “cushion” may be implemented to ensure adequate molten polymer 114 remains within the barrel. For example, the controller 140 may account for a buffer between approximately 5% and approximately 15% beyond the total volume of the mold cavity or cavities 122. Accordingly, in these examples, the controller 140 may require the buffer value, in addition to the volume in the mold cavity or cavities 122, to be present in the barrel 110 prior to performing a shot. Accordingly, in the above example where each shot requires approximately 20% of the volume of molten polymer 114 disposed within the barrel 110, the controller may only allow four successive shots to be completed prior to initiating a recovery profile in order to account for the 5-15% buffer. Other examples are possible.

In some approaches, the controller 140 and the sensor 128 may cooperate to perform “on-the-fly” calculations of available molten polymer 114. More specifically, upon the machine 100 performing a first shot, the controller 140 may cause the sensor 128 to determine a remaining volume of molten polymer 114 disposed within the barrel 110. The controller 140 may then determine whether this remaining volume is greater than the total, fill volume of the mold cavity or cavities 122 (plus any additional desired buffer value), and if so, the controller 140 may then cause the reciprocating screw 112 to advance to inject an additional shot of molten polymer 114 into the mold cavity 122. The process of injecting additional shots of molten polymer 114 may continue until the controller 140 determines that there is not enough molten polymer 114 remaining within the barrel 110 to perform a subsequent shot. In some examples, the controller 140 may additionally ascertain whether the screw 122 has a sufficient travel length to inject subsequent shots of molten polymer 114 into the mold cavity 122. Other examples are possible.

Upon completion of these injection cycles (and in some examples, upon determining that a desired number of shots have run, or that there is inadequate remaining volume of molten polymer 114 in the barrel 110 to complete another shot), a recovery profile is commenced (step “VII” of FIG. 2) where the reciprocating screw 112 returns to the first position 112a. At this time, the controller may perform an additional comparison of available molten polymer 114 within the barrel 110 or may simply commence a first cycle due to the assumption that there will be sufficient molten polymer 114 within the barrel 110 to perform a first short. However, in some environments, it may be desired to incorporate the comparison prior to injecting the first shot to act as a failsafe to ensure the molten polymer 114 successfully enters the barrel 110.

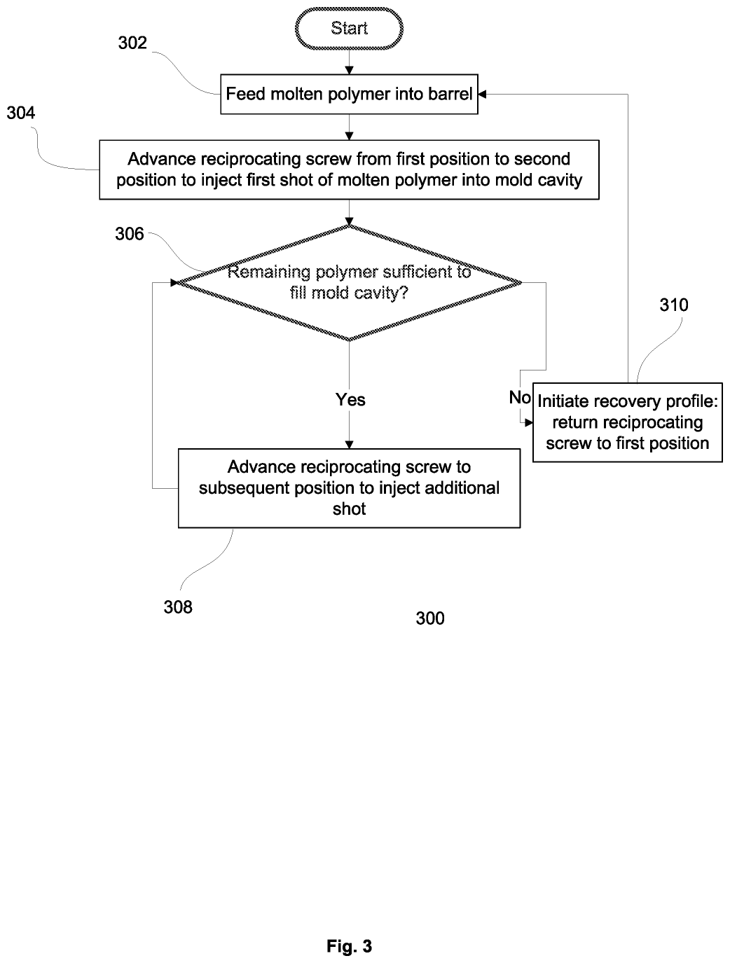

As illustrated in FIG. 3, an example variable volume recovery process 300 is described. First, at a step 302, the molten polymer 114 is fed into the barrel 110. At a step 304, the reciprocating screw 112 is advanced to inject a shot of molten polymer 114 into the mold cavity 122. At a step 306, the controller 140 uses the sensed value from the sensor 128 to determine whether the remaining molten polymer 114 within the barrel 110 is sufficient to fill the mold cavity 122. If the remaining molten polymer 114 disposed within the barrel 110 is sufficient to fill the mold cavity 122, the process 300 proceeds to step 308, where the reciprocating screw 112 is again advanced to a subsequent position to inject an additional shot of molten polymer. The process 300 then returns to step 306, where the controller 140 uses the sensed value form the sensor 128 to determine whether the remaining molten polymer 114 within the barrel 110 is sufficient to fill the mold cavity 122. If, at step 306, the remaining molten polymer 114 is not sufficient to fill the mold cavity 122, the process 300 advances to a step 310, whereby a recovery profile is initiated that causes the reciprocating screw 112 to return to the first position. The process 300 then proceeds to step 302, where molten polymer 114 is fed into the barrel 110.

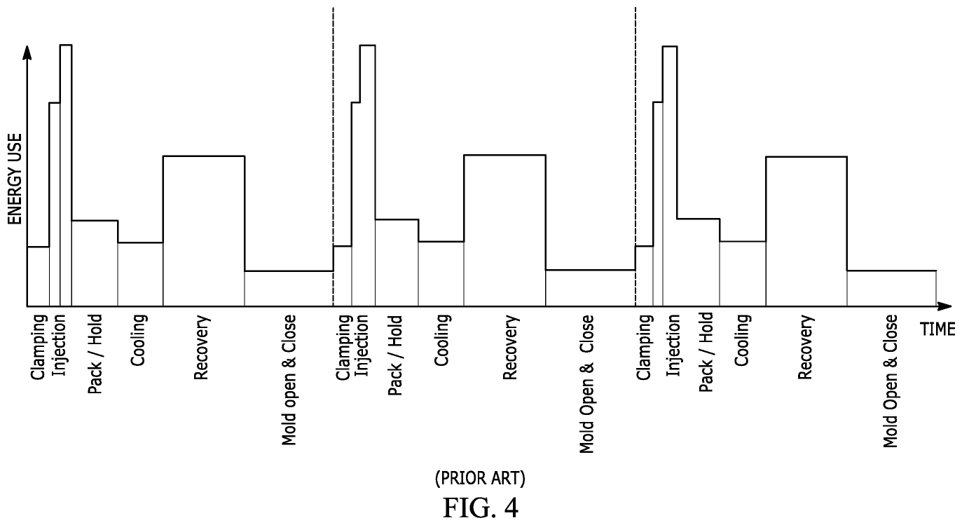

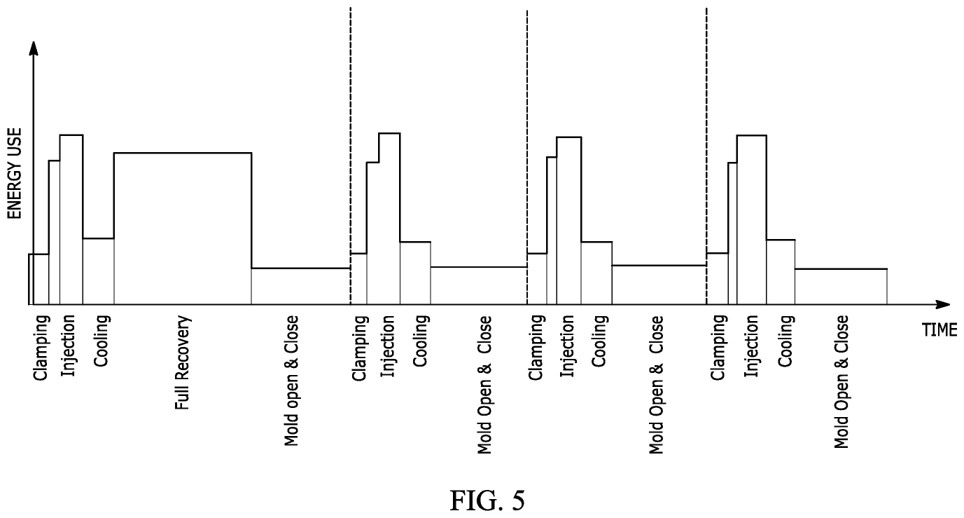

By incorporating a variable volume recovery process, the machine 100 may use substantially less energy than conventional injection molding machines over extended periods. More specifically, when comparing 10 shots of molten polymer under a variable volume recovery process with 10 shots of molten polymer under conventional recovery approaches, energy is substantially reduced due to the reciprocating screw 112 returning to the initial position 112a fewer times compared to conventional processes that require the reciprocating screw to return to the initial position after each shot. As a result, less energy is consumed overall. With reference to FIGS. 4 and 5, conventional injection molding processes, where the screw recovers after each successive shot (FIG. 4), requires substantially more energy than the system represented by FIG. 5, where after a first shot, the machine undergoes a full screw recovery but does not recover in the three subsequent shots. So configured, in the illustrated example, the variable volume recovery processes described herein may inject four injection cycles using the same amount of energy required to perform three injection cycles using conventional approaches. It will be appreciated that various factors such as, for example, machine size (tonnage) and type (e.g., hydraulic, hybrid, electric, etc.) may impact the ratio of the number of comparable cycles that can be performed using variable volume recovery relative to conventional recovery approaches.

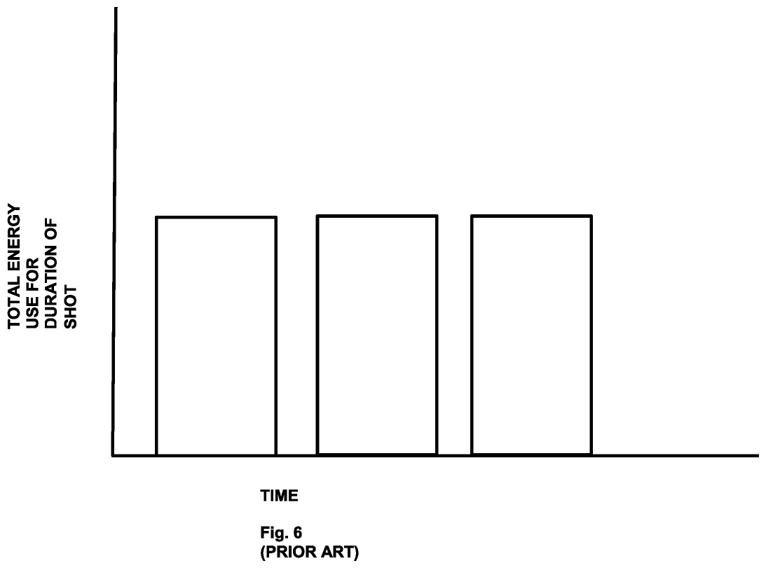

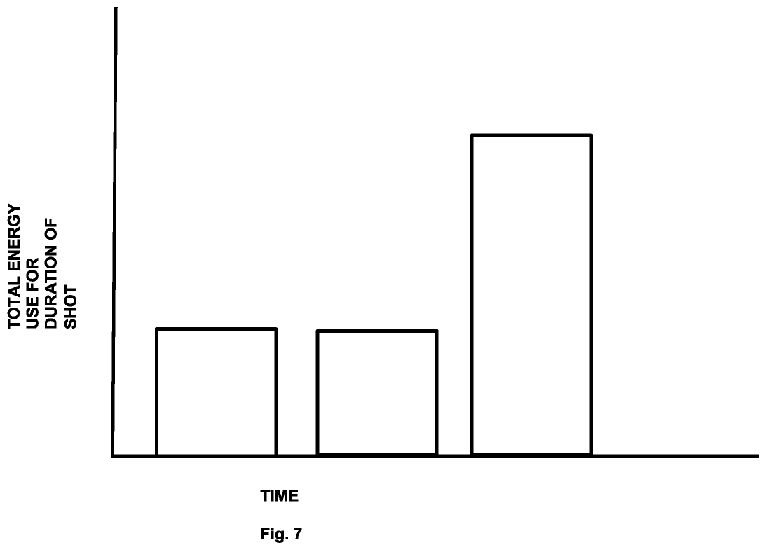

With reference to FIGS. 6 and 7, example total energy consumption graphs are provided for a plurality of shots (e.g., for three successive shots). As illustrated in FIG. 6, in conventional approaches, the total energy usage for successive shots is approximately constant due to the screw recovering after each shot. However, in the illustrated example of FIG. 7, which uses the example variable volume recovery processes described herein, the highest energy consumption value of the plurality of successive shots occurs in the last of the plurality of successive shots. Accordingly, the variable volume recovery process uses less energy per shot where the screw does not recover, but the overall energy consumed is also less compared to conventional recovery approaches.

Additionally, in some environments, the variable volume recovery process described herein may result in time savings. In systems where it takes more time for the reciprocating screw to recover than it does to cool and eject the part, using the variable volume recovery process described herein will result in a cycle time savings, as the machine need not wait for the screw to recover before injecting a subsequent shot. Rather, the variable volume recovery process described herein allows subsequent shots to be injected immediately after the molded part is cooled and ejected from the mold cavity 122 (and the mold cavity 122 is again closed). By eliminating the ramping up and down of the reciprocating screw 114 to one injection cycle out of every three to six cycles, the process requires less time overall. Such a system may be of particular benefit to molding operations in which recovery time is longer than the necessary pre-ejection cooling time, such that the recovery operation is effectively the controlling variable in cycle times.

It is appreciated that any number of alternative features and/or approaches may be incorporated into the variable volume recovery process. For example, in some approaches, the controller 140 may be configured to automatically cause the reciprocating screw 112 to recover to the first position 112 after the machine 100 experiences a shut down as a safety measure. Further, in some examples, the controller may know how many parts may be made in a multi-part mold, and may be capable of advancing the screw to mold a certain number of parts if there is insufficient molten polymer remaining in the barrel 110 to fully fill each mold cavity. In such examples, the approaches described herein may be used to more fully utilize the molten plastic material disposed within the barrel and/or to more accurately fill a desired production run. Other examples are possible.

In some approaches, the injection molding machine may inject shots of varying volumes. For example, in injection molding machines where the mold may dynamically close a desired number of mold cavities, the machine may determine the fill volume of open mold cavities and inject a shot of molten plastic material having a corresponding volume. Further in examples where a component (i.e., a check ring) may be exhibiting a malfunction, the screw may need to travel a different length in order to compensate for this malfunction. Further, in some examples, there may be potential for a mold, such as a cube mold, to have different cavity and part layouts for each corresponding face of the cube, which may require the need for variable volumes of material depending on which mold face is active. Other examples are possible.

The variable volume recovery processes described herein may advantageously be incorporated into conventional injection molding systems, injection molding systems incorporating low, substantially constant pressure approaches, and any other systems.

So configured, the variable volume recovery process results in both energy and time savings. Further, the variable volume recovery process results in less wear on the reciprocating screw due to reducing the number of times it must be returned to its initial position. Even in systems using an electric injection molding machine, the longevity of the servomotor may be prolonged due to experiencing fewer cycles with longer times, which is preferable to an increased number of cycles having shorter duration because inertia required to get initiate the recovery profile is typically one of the largest drains on the motor.

While a thermoplastic injection molding process is described herein, it will be appreciated that the embodiments in this disclosure may also relate to other injection molding processes, such as, for example, metal injection molding (MIM), reaction injection molding (RIM), liquid injection molding (LIM), structural foam molding, and liquid crystal polymer (LCP) molding. Other examples are possible.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

The patent claims at the end of this patent application are not intended to be construed under 35 U.S.C. § 112(f) unless traditional means-plus-function language is expressly recited, such as “means for” or “step for” language being explicitly recited in the claim(s). The systems and methods described herein are directed to an improvement to computer functionality, and improve the functioning of conventional computers.

What is claimed is:

1. A method for controlling an injection molding machine having a mold forming a mold cavity, the injection molding machine being controlled according to an injection cycle, the method comprising:
feeding a molten polymer into a barrel containing a screw disposed in a first position;
advancing the screw a first instance, from the first position to a second position, to inject the molten polymer into the mold cavity to form a first molded part or a first set of molded parts;
ejecting a first molded part or a first set of molded parts from the mold cavity;
advancing the screw a second instance, from the second position to a third position, to inject the molten polymer into the mold cavity to form a second additional molded part or a second set of molded parts;
ejecting a second molded part or a second set of molded parts from the mold cavity; and
after the second advancing instance, commencing a recovery profile in which the screw is returned to the first position.

2. The method of claim 1, further comprising the step of commencing a hold pattern after the step of advancing the screw from the first position to the second position.

3. The method of claim 1, further comprising the step of determining, via a sensor, a sensed volume of molten polymer disposed within the barrel or a suitable proxy for a sensed volume of molten polymer disposed within the barrel.

4. The method of claim 3, wherein the sensor comprises at least one of a screw position sensor or a melt travel sensor.

5. The method of claim 3, further comprising the step of comparing the sensed volume of molten polymer disposed within the barrel with a fill volume associated with the mold cavity.

6. The method of claim 5, wherein the screw is advanced from the second position to the third position only if the volume of molten polymer disposed in the barrel is greater than the fill volume associated with the mold cavity.

7. An injection molding machine comprising:
an injection unit having a mold forming a mold cavity having a fill volume and a barrel containing a screw that is movable within the barrel, the injection unit adapted to receive and inject a molten plastic material into the mold cavity via the screw to form a molded part;
a sensor coupled with the injection unit, the sensor adapted to measure at least one characteristic of the molten polymer in the barrel; and
a controller coupled with the injection unit and the sensor, the controller adapted to control operation of the injection molding machine according to an injection cycle;
wherein the controller is adapted to:
compare the measured characteristic of the barrel with the fill volume of the cavity, and
upon the measured characteristic of the barrel exceeding a threshold value, advance the screw from the first position to a second position to inject the molten polymer into the mold cavity to form a first molded part or a first set of molded parts.

8. The injection molding machine of claim 7, wherein, prior to initiating a recovery cycle of the screw, the controller is further adapted to compare a second characteristic of the barrel sensed by the sensor with the fill volume of the cavity, wherein if the second characteristic of the molten polymer exceeds the threshold value, the controller is adapted to advance the screw from the second position to a third position to inject the molten polymer into the mold cavity to form a second molded part or a second set of molded parts.

9. The injection molding machine of claim 8, the controller further being adapted to compare a third characteristic of the barrel sensed by the sensor with the fill volume of the cavity, wherein if the third characteristic of the molten polymer exceeds the threshold value, the controller is adapted to advance the screw from the third position to a fourth position to inject the molten polymer into the mold cavity to form an additional molded part.

10. The injection molding machine of claim 8, wherein if the second characteristic of the molten polymer is less than the threshold value, the controller is adapted to initiate the recovery cycle of the screw to move the screw to the first position.

11. The injection molding machine of claim 7, wherein the sensor is adapted to measure a sensed volume of molten polymer disposed within the barrel.

12. The injection molding machine of claim 11, wherein the sensor comprises at least one of a screw position sensor or a melt travel sensor.

13. The injection molding machine of claim 7, wherein the threshold value includes a buffer volume.

14. A non-transitory computer-readable storage medium storing processor-executable instructions that, when executed, cause one or more processors to:
feed a molten polymer into a barrel containing a screw disposed in a first position;
commence an injection cycle by transmitting a signal to an actuator that advances the screw a first instance, from the first position to a second position, to inject the molten polymer into the mold cavity to form a molded part;
eject a first molded part or a first set of molded parts from the mold cavity;
advance the screw a second instance, from the second position to a third position, to inject the molten polymer into the mold cavity to form a molded part;
after the second advancing instance, eject a second molded part or a second set of molded parts from the mold cavity; and
commence a recovery profile in which the screw is returned to the first position.

15. The non-transitory computer-readable storage medium of claim 14, further being adapted to cause one or more processors to commence a hold pattern after advancing the screw from the first position to the second position.

16. The non-transitory computer-readable storage medium of claim 14, further being adapted to cause one or more processors to determine, via a sensor, a sensed volume of molten polymer disposed within the barrel.

17. The non-transitory computer-readable storage medium of claim 16, further being adapted to cause one or more processors to compare the sensed volume of molten polymer remaining in the barrel with a fill volume associated with the mold cavity.

18. The non-transitory computer-readable storage medium of claim 17, wherein if the volume of molten polymer remaining in the barrel is greater than the fill volume associated with the mold cavity, further causing the one or more processors to advancing the screw from the second position to the third position.

19. A method for controlling an injection molding machine having a mold forming a mold cavity, the injection molding machine being controlled according to an injection cycle, the method comprising:
feeding a molten polymer into a barrel containing a screw;
injecting a plurality of intermediate shots of molten polymer into the mold cavity by advancing the screw;
for each of the plurality of intermediate shots, performing a cooling step whereby the molten polymer cools within the mold cavity and ejecting a molded part or a set of molded parts from the mold cavity, wherein no energy is consumed between the cooling step and the ejecting step for the plurality of intermediate shots;
injecting a final shot of molten polymer into the mold cavity by advancing the screw;
performing a final cooling step and a final ejecting step where a molded part or a set of molded parts is ejected from the mold cavity, wherein energy is consumed between the final cooling step and the final ejecting step.

20. The method of claim 20, wherein a highest energy consumption value of the injection cycle occurs in the final shot of molten polymer injected into the mold cavity.

21. A method for controlling an injection molding machine having a mold forming a mold cavity, the injection molding machine being controlled according to an injection cycle, the method comprising:
feeding a molten polymer into a barrel containing a screw;
injecting a plurality of successive shots of molten polymer into the mold cavity by advancing the screw;
wherein a highest energy consumption value of the injection cycle occurs in a final shot of the plurality of successive shots of molten polymer injected into the mold cavity.
